(19) United States
(12) Patent Application Publication
(10) Pub. No.: US 2014/0240473 A1
(43) Pub. Date: Aug. 28, 2014

(54) STEREOSCOPIC IMAGE PROCESSING APPARATUS AND METHOD THEREOF

(71) Applicant: MEDIATEK INC., Taiwan (CN)

(72) Inventor: Chao-Chung Cheng, Tainan City (TW)

(21) Appl. No.: 14/347,735

(22) PCT Filed: Oct. 12, 2011
(86) PCT No.: PCT/CN2011/080693

§ 371 Date: Mar. 27, 2014

(51) Int. Cl. H04N 13/04

(52) U.S. Cl. CPC H04N 13/0497; H04N 13/0434
USPC 348/53

(57) ABSTRACT

A stereoscopic display apparatus is provided. The stereoscopic display apparatus includes a liquid crystal panel, a backlight, a controller and an active polarizer disposed adjacent to the liquid crystal panel. The liquid crystal panel alternately displays a left image and a right image to passive polarized glasses according to a synchronization signal. The backlight supplies light to the liquid crystal panel. The controller provides the left image, the right image and the synchronization signal according to a video input signal. The active polarizer polarizes the light from the backlight in response to the synchronization signal to form two viewing zones, such that the left image and the right image are observed by the passive polarized glasses via the corresponding zones, respectively.

### CROSS REFRENCE TO RELATED APPLICATIONS

This application is a National Phase of PCT/CN2011/080693 filed on Oct. 12, 2011.

### TECHNICAL FIELD

The present invention is related to a stereoscopic display apparatus, and more particularly, to a stereoscopic display apparatus with an active polarizer.

### BACKGROUND

A three-dimensional (3D) image is formed according to the principle of stereoscopic vision by the eyes of a human being. Binocular parallax, which is generated, due to a distance of about 65 mm, between a human's eyes, can be considered as the most important factor inducing a cubic effect.

In recent years, 3D video content, in which video can be viewed in a three-dimensional manner, has attracted much development attention. There are two types of systems for viewing 3D video: a glasses system using polarizing filter glasses (passive polarized glasses) or shutter glasses; and a naked eye system not using glasses, such as for example, a lenticular system and a parallax barrier system.

### SUMMARY

A stereoscopic display apparatus and display method thereof are provided. An embodiment of a stereoscopic display apparatus is provided. The stereoscopic display apparatus comprises a liquid crystal panel, a backlight, a controller and an active polarizer disposed adjacent to the liquid crystal panel. The liquid crystal panel alternately displays a left image and a right image to passive polarized glasses according to a synchronization signal. The backlight supplies light to the liquid crystal panel. The controller provides the left image, the right image and the synchronization signal according to a video input signal. The active polarizer polarizes the light from the backlight in response to the synchronization signal to form two viewing zones, such that the left image and the right image are observed by the passive polarized glasses via the corresponding zones, respectively.

Furthermore, another embodiment of a stereoscopic display apparatus is provided. The stereoscopic display apparatus comprises a liquid crystal panel, a backlight, an active polarizer disposed adjacent to the liquid crystal panel and a controller. The liquid crystal panel alternately displays a left image and a right image to passive polarized glasses. The backlight supplies light to the liquid crystal panel. The controller provides the left image, the right image and the synchronization signal according to a video input signal. The active polarizer comprises a plurality of pixels. when the left and right images are partially displayed on the same frame of the liquid crystal panel according to the synchronization signal, a part of the pixels are operated in a first mode to transmit the light from the backlight to a left glass of the passive polarized glasses for displaying the left image, and the other part of the pixels are operated in a second mode to transmit the light from the backlight to a right glass of the passive polarized glasses for displaying the right image.

Furthermore, an embodiment of a display method for a stereoscopic display apparatus is provided. A left image and a right image are alternately displayed in a liquid crystal panel of the stereoscopic display apparatus. An active polarizer of the stereoscopic display apparatus is controlled to dynamically form a first viewing zone and a second viewing zone, such that the right and left images are respectively observed by a passive polarized glasses via the first and second viewing zones when the left and right images are partially displayed on the same frame of the liquid crystal panel. The active polarizer is adjacent to the liquid crystal panel in the stereoscopic display apparatus.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a stereoscopic display system illustrating a user wearing passive glasses to observe a stereoscopic image provided by a stereoscopic display apparatus;

FIG. 2 shows a schematic illustrating the stereoscopic display apparatus of FIG. 1 according to an embodiment of the invention;

FIG. 3 shows a display method for a stereoscopic display apparatus according to an embodiment of the invention;

FIG. 4 shows an example illustrating that the active polarizer of FIG. 2 is fully synchronous with the LC panel according to an embodiment of the invention;

FIG. 5 shows a schematic illustrating the frames sequentially displayed by the 3D display and the shutter operations of the conventional shutter glasses;

FIG. 6 shows a schematic illustrating the frames sequentially displayed by the LC panel and the viewing zones VZL and VZR dynamically formed by the active polarizer of FIG. 2 according to an embodiment of the invention;

FIG. 7 shows an example illustrating that the active polarizer of FIG. 2 is line-based synchronous with the LC panel according to an embodiment of the invention;

FIG. 8 shows a schematic illustrating the frames sequentially displayed by the LC panel and the viewing zones VZL and VZR dynamically formed by the active polarizer of FIG. 2 according to another embodiment of the invention; and

FIG. 9 shows a stereoscopic display apparatus according to another embodiment of the invention.

### DETAILED DESCRIPTION

The following description is of the best-contemplated mode of carrying out the invention.

This description is made for the purpose of illustrating the general principles of the invention and should not be taken in a limiting sense. The scope of the invention is best determined by reference to the appended claims.

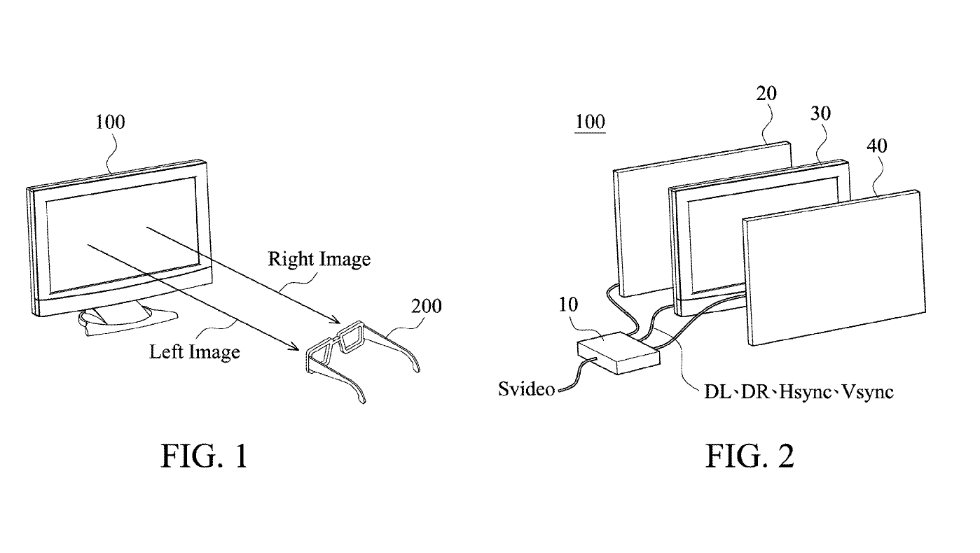

FIG. 1 shows a stereoscopic display system illustrating a user wearing passive glasses 200 to observe a stereoscopic image provided by a stereoscopic display apparatus 100 according to an embodiment of the invention. FIG. 2 shows a schematic illustrating the stereoscopic display apparatus 100 of FIG. 1 according to an embodiment of the invention. Referring to FIG. 1 and FIG. 2 together, the stereoscopic display apparatus 100 comprises a controller 10, a backlight 20, a liquid crystal (LC) panel 30 and an active polarizer 40. In the embodiment, the LC panel 30 is disposed between the backlight 20 and the active polarizer 40. The controller 10 controls the backlight 20 to supply light to the LC panel 30, thus the user wearing the passive glasses 200 can observe the image that the LC panel is displaying. Furthermore, the controller 10 alternately provides a left data DL and a right data DR to the LC panel 30 according to a video signal Svideo. Simultaneously, the controller 10 also provides the synchronization signals, such as a horizontal synchronization signal Hsync and a vertical synchronization signal Vsync to the LC panel 30 for scanning Thus, according to the left and right data DL and DR and the synchronization signals Hsync and Vsync, the LC panel 30 can alternately display the left and right images to the passive glasses 200. In response to the synchronization signals Hsync and Vsync and the left and right data DL and DR, the controller 10 synchronously controls the active polarizer 40. In one embodiment, the controller 10 is implemented in a timing controller of the stereoscopic display apparatus 100. Furthermore, the passive glasses 200 comprises two different polarized glasses each for passing an individual polarized light.

In the active polarizer 40, each pixel can operate in two modulating modes: a left-eye modulating mode and a right-eye modulating mode. In a right-eye modulating mode, the light from the backlight 20 is modulated to a first polarized light that can be transmitted to the right eye of the user via the right glass of the passive glasses 200 and can not be transmitted to the left eye of the user due to the first polarized light is blocked by the left glass of the passive glasses 200. In a left-eye modulating, the light from the backlight 20 is modulated to a second polarized light that can be transmitted to the left eye of the user via the left glass of the passive glasses 200 and can not be transmitted to the right eye of the user due to the second polarized light is blocked by the right glass of the passive glasses 200. Therefore, the pixels of the active polarizer 40 operating in a left-eye modulating mode can form a left viewing zone, and the pixels of the active polarizer 40 operating in a right-eye modulating mode can form a right viewing zone. Thus, the left and right eyes of the user wearing passive glasses 200 can observe the image displayed by the pixels of the LC panel corresponding to the left and right viewing zones of the active polarizer 40, respectively. In one embodiment, the first polarized light and the second polarized light are orthogonal.

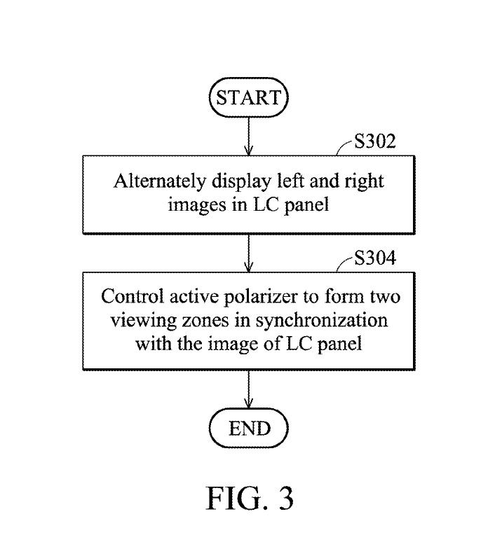

FIG. 3 shows a display method for a stereoscopic display apparatus according to an embodiment of the invention. First, in step S302, a liquid crystal panel (e.g. 30 of FIG. 2) of the stereoscopic display apparatus alternately displays a left image and a right image with a scanning manner, wherein the scanning manner is determined according to the synchronization signals Vsync and Hsync corresponding to a resolution of the stereoscopic display apparatus. Next, in step S304, an active polarizer (e.g. 40 of FIG. 2) of the stereoscopic display apparatus dynamically forms a viewing zone VZL for the left image and a viewing zone VZR for the right image in synchronization with the image of the liquid crystal panel in the stereoscopic display apparatus.

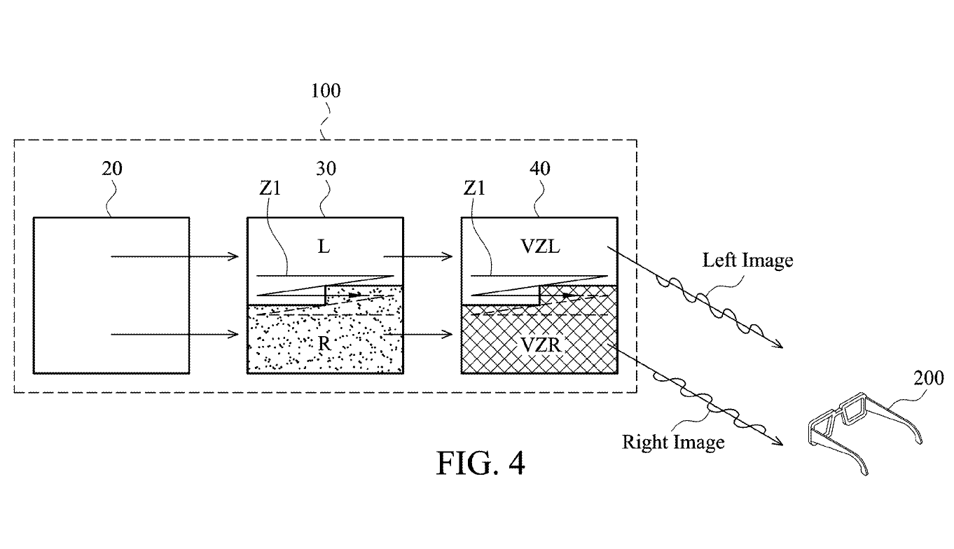

FIG. 4 shows an example illustrating that the active polarizer 40 of FIG. 2 is fully synchronous with the LC panel 30 according to an embodiment of the invention, i.e. per pixel synchronous in response to the horizontal synchronization signal Hsync. In FIG. 4, the backlight 20 supplies light to the LC panel 30. In the LC panel 30, a scanning/update manner Z1 is used to alternately display the right image R and the left image L. Simultaneously, the pixels of the active polarizer 40 are controlled to operate in a left-eye modulating mode and a right-eye modulating mode in synchronization with the LC panel 30, to form a viewing zone VZL and a viewing zone VZR. Thus, the left image L can be observed by the left eye of the user via the viewing zone VZL and the left glass of the passive glasses 200, and the right image R can be observed by the right eye of the user via the viewing zone VZR and the right glass of the passive glasses 200. Therefore, no right image R will be observed by the left eye of the user wearing the passive glasses 200 via the left viewing zone VZL and no left image L will be observed by the right eye of the user via the right viewing zone VZR; thereby no cross talk occurs. In general, when a portion of one eye image is visible in the other eye, cross talk occurs, and the image can appear blurred or a second or double image appears in regions of a scene being viewed creating a phenomenon called ghosting. Specifically, when a frame of the LC panel 30 is updated from one eye image to the other eye image according to a specific update manner, the pixels of the active polarizer 40 corresponding to the pixels of the LC panel 30 that have been updated and that have not been updated, are viewing by the dedicated eyes of the user, respectively.

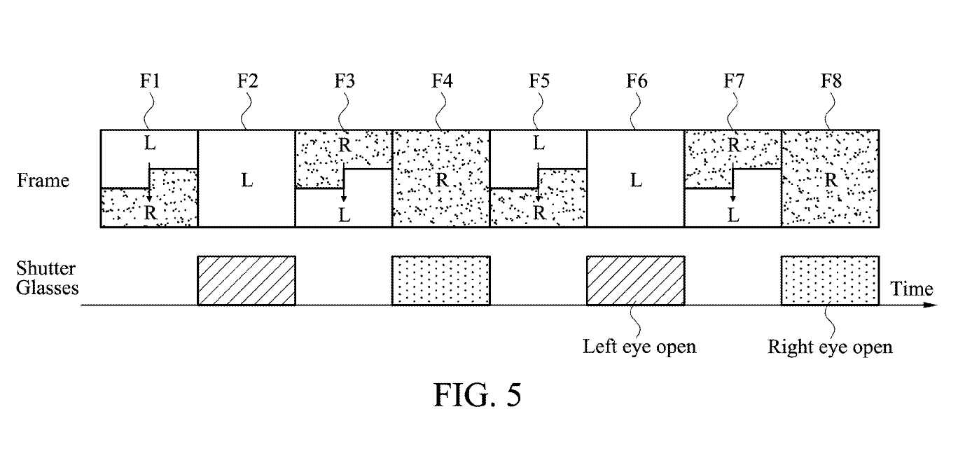

Compared to wearing shutter glasses to view 3D video, wearing the passive glasses 200 to view the stereoscopic display apparatus 100 can prevent cross talk and reduce darkness of visual range for an observer. This is because the shutter glasses control the opening and closing of a shutter for a left eye and a shutter for a right eye in accordance with a switching signal SW of a conventional 3D display. As shown in FIG. 5, FIG. 5 shows a schematic illustrating the frames sequentially displayed by the 3D display and the shutter operations of the conventional shutter glasses controlled by the switching signal SW. In FIG. 5, frames F1, F3, F5 and F7 represent the transitions that the display frame is being updated from one eye image to the other eye image, such as the frame F1 represents that the display frame is being updated from a right image R to a left image L, so the left image L and the right image R are partially displayed on the same frame. Frames F2, F4, F6 and F8 represent that only one eye image is displayed on the display frame, such as the frame F2 represents that the left image L is completely displayed on the display frame. In response to the switching signal SW, the shutter glasses repeats opening and closing operations of two shutters, which are a shutter open operation for the left eye as well as a shutter open operation for the right eye and a shutter close operation for the left eye and a shutter close operation for the right eye alternately, so that the shutters are synchronized with the timing signal SW. As a result, in order to prevent cross talk, the switching signal SW is scheduled to prevent the opening operations of shutters to occur during the transitions from one eye image to the other eye image (e.g. the frames F1, F3, F5 and F7), such that only video for the right eye is inputted to the right eye of a user and only video for the left eye is inputted to the left eye of the user. However, the closing operations of shutters will cause a decrease in light transmittance when the user sees objects or landscapes around the display through the shutter glasses.

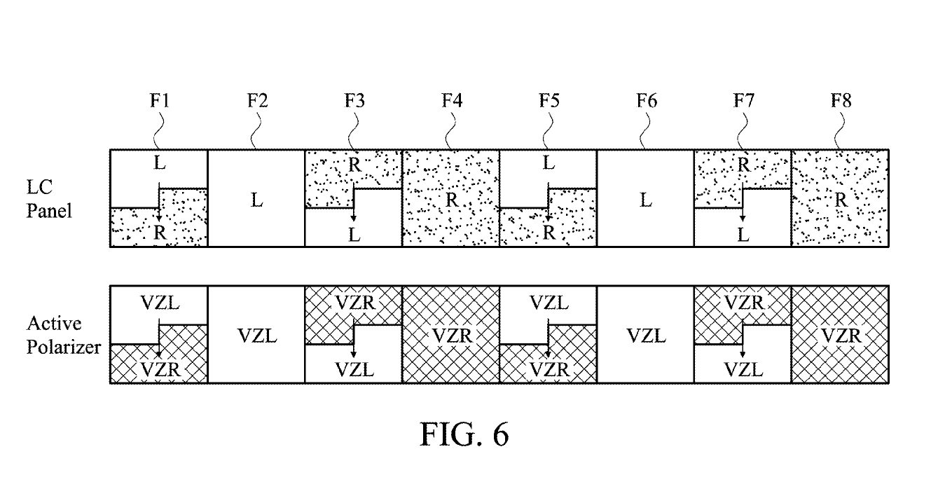

FIG. 6 shows a schematic illustrating the frames sequentially displayed by the LC panel 30 and the viewing zones VZL and VZR dynamically formed by the active polarizer 40 of FIG. 2 according to an embodiment of the invention. In FIG. 6, frames F1, F3, F5 and F7 represent the transitions that the frame of the LC panel 30 is being updated from one eye image to the other eye image, so the left image L and the right image R are partially displayed on the same frame. Frames F2, F4, F6 and F8 represent that only one eye image is displayed on the display frame. In FIG. 6, following the updating state of the LC panel 30, the pixels of the active polarizer 40 are controlled to operate in the corresponding modulating mode, so as to form the viewing zones VZR and VZL in synchronization with the frame of the LC panel 30 pixel by pixel. Thus, no phenomenon that resembles the closing operations of conventional shutters of FIG. 5 occur, thereby increasing illumination and preventing cross talk of a stereoscopic image for a observer wearing the passive glasses.

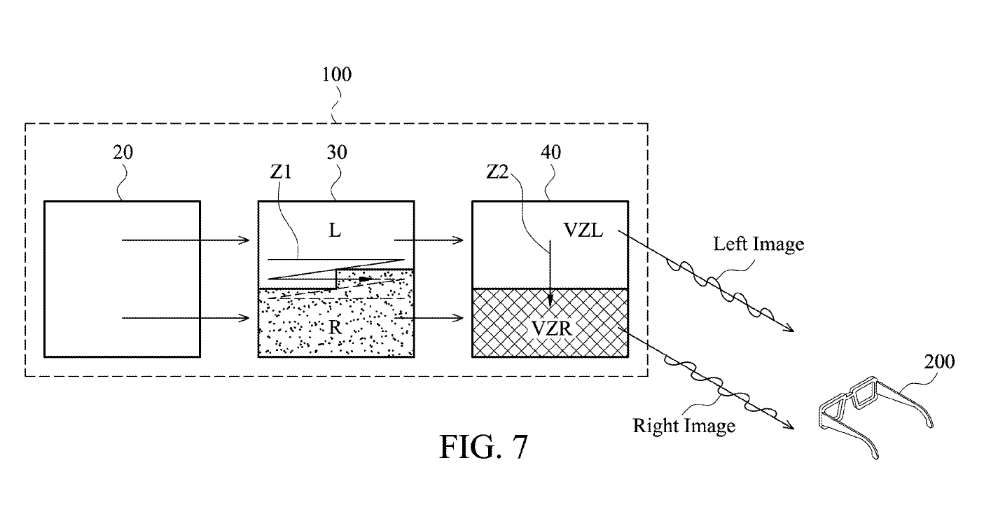

FIG. 7 shows an example illustrating that the active polarizer 40 of FIG. 2 is line-based synchronous with the LC panel 30 according to an embodiment of the invention, i.e. per scan line synchronous in response to the vertical synchronization signal Vsync. In FIG. 7, a scanning/update manner Z1 is used to alternately display the right image R and the left image L in the LC panel 30. Furthermore, the pixels disposed in the same scan line of the active polarizer 40 are controlled to operate in the same modulating mode with a scanning/update manner Z2; that is, in synchronization with the LC panel 30, to form the viewing zones VZR and VZL.

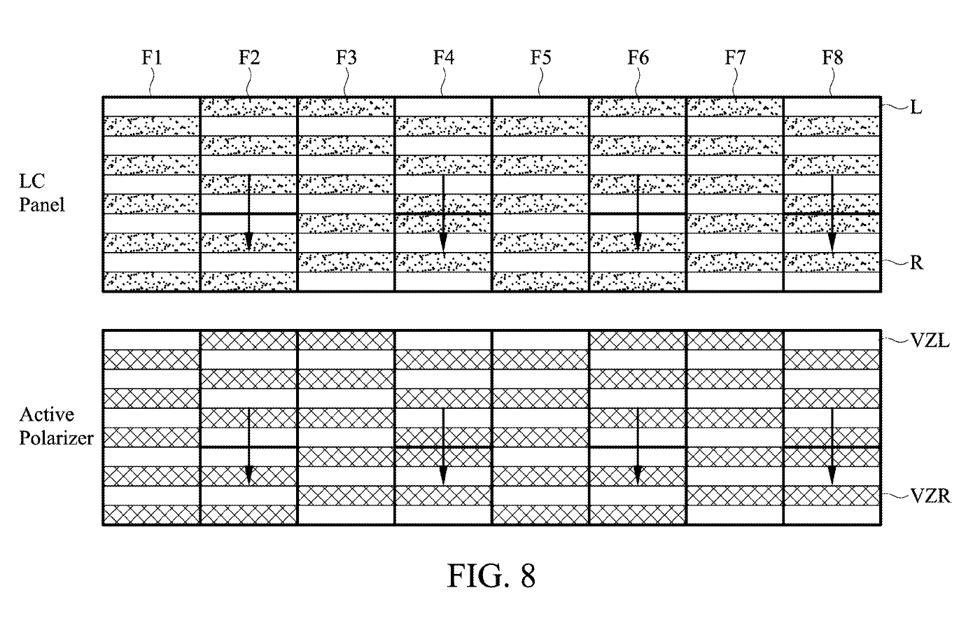

FIG. 8 shows a schematic illustrating the frames sequentially displayed by the LC panel 30 and the viewing zones VZL and VZR dynamically formed by the active polarizer 40 of FIG. 2 according to another embodiment of the invention. In FIG. 8, a horizontal line interleaved scanning/update manner is used to display the right image R and the left image L, wherein a line of the left image L and a line of he right image R are alternatively arranged according to each line in a horizontal direction of one frame. As shown in FIG. 8, frames F1 and F5 represent a first format that the left image L is display in even lines and the right image R is display in odd lines, and frames F3 and F7 represent a second format that the left image L is display in odd lines and the right image R is display in even lines. Frames F2 and F6 represent the transitions that the frame of the LC panel 30 is being updated from the first format to the second format, and frames F4 and F8 represent the transitions that the frame of the LC panel 30 is being updated from the second format to the first format. Similarly, following the updating state of the LC panel 30, the pixels of the active polarizer 40 are controlled to operate in the corresponding modulating mode, so as to form the viewing zones VZR and VZL in synchronization with the frame of the LC panel 30. Furthermore, other scanning/update manners can also be used, such as a vertical line interleaved manner or a checker board manner. In a vertical line interleaved manner, a line of the left image L and a line of a right view image are alternatively arranged according to each line in a vertical direction of one frame of the LC panel 30. In a checker board manner, a pel of the left image L and a pel of the right image R are alternatively arranged according to both of horizontal and vertical directions of each pel of one frame of the LC panel 30.

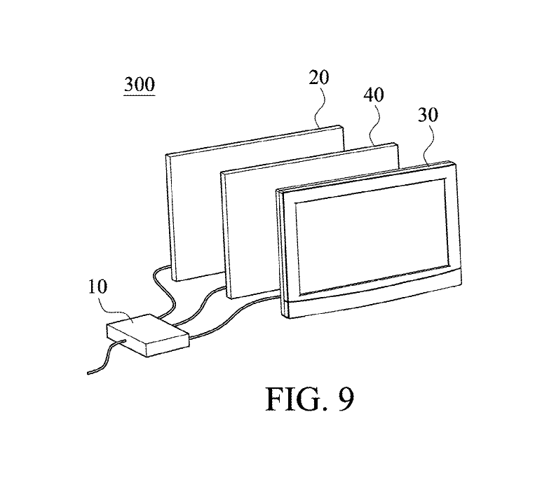

FIG. 9 shows a stereoscopic display apparatus 300 according to another embodiment of the invention. In the stereoscopic display apparatus 300, the active polarizer 40 is disposed between the LC panel 30 and the backlight 20. Therefore, in the active polarizer 40, the pixels operating in a right-eye modulating mode will polarize the light from the backlight 20 to provide a first polarized light to the LC panel 30, and the pixels operating in a left-eye modulating mode will polarize the light from the backlight 20 to provide a second polarized light to the LC panel 30, thus dynamically forming the viewing zones VZR and VZL in synchronization with the LC panel 30 for an observer wearing passive glasses.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A stereoscopic display apparatus, comprising:
a liquid crystal panel, alternately displaying a left image and a right image to passive polarized glasses according to a synchronization signal;
a backlight, supplying light to the liquid crystal panel;
a controller, providing the left image, the right image and the synchronization signal according to a video input signal; and
an active polarizer disposed adjacent to the liquid crystal panel, polarizing the light from the backlight in response to the synchronization signal to form two viewing zones, such that the left image and the right image are observed by the passive polarized glasses via the corresponding zones, respectively.

2. The stereoscopic display apparatus as claimed in claim 1, wherein when a frame of the liquid crystal panel is being updated from the left to right image or from the right to left image according to a horizontal synchronization signal, the pixels of the active polarizer corresponding to the pixels of the liquid crystal panel that have been updated, form a first viewing zone and the pixels of the active polarizer corresponding to the pixels of the liquid crystal panel that have not been updated, form a second viewing zone.

3. The stereoscopic display apparatus as claimed in claim 1, wherein when a frame of the liquid crystal panel is being updated from the left to right image or from the right to left image according to a vertical synchronization signal, the pixels of the active polarizer corresponding to the scan lines of the liquid crystal panel that have been updated, form a first viewing zone and the pixels of the active polarizer corresponding to the scan lines of the liquid crystal panel that have not been updated, form a second viewing zone.

4. The stereoscopic display apparatus as claimed in claim 1, wherein the liquid crystal panel is disposed between the backlight and the active polarizer.

5. The stereoscopic display apparatus as claimed in claim 1, wherein the active polarizer is disposed between the backlight and the liquid crystal panel.

6. A stereoscopic display apparatus, comprising:
a liquid crystal panel, alternately displaying a left image and a right image to passive polarized glasses;
a backlight, supplying light to the liquid crystal panel;
a controller, providing the left image, the right image and the synchronization signal according to a video input signal; and
an active polarizer disposed adjacent to the liquid crystal panel, comprising a plurality of pixels, wherein when the left and right images are partially displayed on the same frame of the liquid crystal panel according to the synchronization signal, a part of the pixels are operated in a first mode to transmit the light from the backlight to a left glass of the passive polarized glasses for displaying the left image, and the other part of the pixels are operated in a second mode to transmit the light from the backlight to a right glass of the passive polarized glasses for displaying the right image.

7. The stereoscopic display apparatus as claimed in claim 6, wherein the liquid crystal panel alternately displays the left image and the right image according to the synchronization signal, and each of the pixels of the active polarizer are operating in the same mode when only one image of the left image and the right image is displayed in a frame of the liquid crystal panel, such that the one image is completely observed by the passive polarized glasses.

8. The stereoscopic display apparatus as claimed in claim 7, wherein when the frame of the liquid crystal panel is being updated from the one image to the other image according to a horizontal synchronization signal, the pixels of the active polarizer corresponding to the pixels of the liquid crystal panel that have been updated, are operated in the mode different from the pixels of the active polarizer corresponding to the pixels of the liquid crystal panel that have not been updated.

9. The stereoscopic display apparatus as claimed in claim 7, wherein when the frame of the liquid crystal panel is being updated from the one image to the other image according to a vertical synchronization signal, the pixels of the active polarizer corresponding to the scan lines of the liquid crystal panel that have been updated, are operated in the mode different from the pixels of the active polarizer corresponding to the scan lines of the liquid crystal panel that have not been updated.

10. The stereoscopic display apparatus as claimed in claim 6, wherein the liquid crystal panel is disposed between the backlight and the active polarizer.

11. The stereoscopic display apparatus as claimed in claim 6, wherein the active polarizer is disposed between the backlight and the liquid crystal panel.

12. A display method for a stereoscopic display apparatus, comprising:
alternately displaying a left image and a right image in a liquid crystal panel of the stereoscopic display apparatus; and
controlling an active polarizer of the stereoscopic display apparatus to dynamically form a first viewing zone and a second viewing zone, such that the right and left images are respectively observed by a passive polarized glasses via the first and second viewing zones when the left and right images are partially displayed on the same frame of the liquid crystal panel,
wherein the active polarizer is adjacent to the liquid crystal panel in the stereoscopic display apparatus.

13. The display method as claimed in claim 12, wherein the pixels of the active polarizer of the stereoscopic display apparatus that are operating in a first mode form the first viewing zone, so as to transmit light from a backlight to a right glass of the passive polarized glasses, and the pixels of the active polarizer of the stereoscopic display apparatus that are operating in a second mode form the second viewing zone, so as to transmit the light from the backlight to a left glass of the passive polarized glasses.

14. The display method as claimed in claim 13, wherein when a frame of the liquid crystal panel is being updated from the left to right image or from the right to left image according to a horizontal synchronization signal, the pixels of the active polarizer corresponding to the pixels of the liquid crystal panel that have been updated, are operated in the mode different from the pixels of the active polarizer corresponding to the pixels of the liquid crystal panel that have not been updated.

15. The display method as claimed in claim 13, wherein when a frame of the liquid crystal panel is being updated from the left to right image or from the right to left image according to a vertical synchronization signal, the pixels of the active polarizer corresponding to the scan lines of the liquid crystal panel that have been updated, are operated in the mode different from the pixels of the active polarizer corresponding to the scan lines of the liquid crystal panel that have not been updated.

16. The display method as claimed in claim 12, wherein the liquid crystal panel is disposed between the backlight and the active polarizer in the stereoscopic display apparatus.

17. The display method as claimed in claim 12, wherein the active polarizer is disposed between the backlight and the liquid crystal panel in the stereoscopic display apparatus.
